(19) United States
(12) Patent Application Publication
(10) Pub. No.: US 2024/0381902 A1
(43) Pub. Date: Nov. 21, 2024

(54) NUTRITIONAL EFFERVESCENT RODS

(71) Applicant: Justin D. Horne, Lynnwood, WA (US)

(72) Inventor: Justin D. Horne, Lynnwood, WA (US)

(21) Appl. No.: 18/663,739

(22) Filed: May 14, 2024

Related U.S. Application Data
(60) Provisional application No. 63/467,979, filed on May 21, 2023.

(51) Int. Cl. A23L 2/40; A23L 2/395; A23L 2/58; A23L 2/60; A23L 2/68; A23L 33/105; A23L 33/125; A23L 33/16

(52) U.S. Cl. CPC A23L 2/40; A23L 2/395; A23L 2/58; A23L 2/60; A23L 2/68; A23L 33/105; A23L 33/125; A23L 33/16

(57) ABSTRACT

The present invention relates to an effervescent elongated solid nutritional composition. The effervescent elongated solid nutritional composition includes a carbohydrate source and effervescing agent. The effervescent elongated solid nutritional composition is free from added sodium and provides energy to a user during sports, cycling, running, gymming, exercise, triathlon, and similar vigorous workouts.

### CROSS-REFERENCE TO RELATED APPLICATION

This patent application claims the benefit of priority of U.S. Provisional Application No. 63/467,979, entitled “NUTRITIONAL EFFERVESCENT RODS,” filed 21 May 2023, which is hereby incorporated herein by reference in its entirety.

### TECHNICAL FIELD OF THE INVENTION

The present invention generally relates to the field of sports nutrition and more particularly, but not exclusively to a nutritional effervescent solid rod. Accordingly, the present specification makes a specific reference to a rod. However, it is to be appreciated that various aspects of the present invention are also equally amenable to other solid elongated nutritional products where effervescence is required.

### BACKGROUND

The realm of endurance sports nutrition, which mainly encompasses cycling, running, and triathlon, offers several products that contain a combination of carbohydrates, electrolytes, and sometimes fats and proteins, providing energy during prolonged activities. Over the past ten years, athletes have increasingly adopted the practice of using powdered blends of carbohydrates and electrolytes, which are similar to the ingredients in pre-mixed sports drinks. However, these powders require athletes to mix them with water in situ to achieve the desired concentration before and during events.

While these products tend to be effective in terms of nutrition, their delivery method is messy, difficult to adjust during the activity, and also results in a significant amount of plastic waste (in the form of scoops and used baggies). Typically, athletes mix the powder with water at the beginning of their activity, using scoops or weight measurements. While this process is only a minor inconvenience in a kitchen setting, it is more challenging in the context of an athletic event, in which athletes need to dispense pre-mixed/measured bags of product, and/or measure and mix directly into their bottles.

Nonetheless, if athletes require more nutrition than they can prepare in advance, they must bring powder with them to mix on the go, which can be problematic. Initially, athletes need to determine the appropriate amount based on various factors, such as weather, exertion level, and activity duration. Subsequently, they need to pack the exact amount of powder in small plastic bags, usually in hourly doses form. However, the fineness of the powder makes it challenging to reseal the bags, resulting in considerable plastic waste.

Beyond the plastic waste, though, these pre-mixed bags present their own challenges. First and most important is the difficulty in mixing the powder on the go. Definitionally, athletes use these bags of powder in fast-paced, high-stress environments, such as long runs, long bike rides, or races. The powder must be carefully dumped from the bag and into a water bottle, which is often difficult in the wind, almost always requires the athlete to stop, and is next to impossible for certain kinds of water bottles with small mouths/openings.

Secondly, because the powder must be pre-measured and premixed for transport and convenience, it is very difficult to adapt to the amount of powder on the go. This is important because varying workloads, heat, gastrointestinal distress, and nutritional needs often require the adaption of the amount of nutrition, but pre-mixed powder stored in plastic bags does not facilitate this. A user can simply pour less powder into their bottle, but they do not know how much less they need to add in. This inaccuracy is very challenging to endurance athletes who require very precise nutrition amounts across long-duration activities, often varying as precisely as individual grams per hour of activity.

Presently, companies have developed dissolvable/effervescent tablets that deliver effective quantities of electrolytes and are designed to be used before and during endurance athletic events. However, these electrolyte tablets contain zero or very little carbohydrate, requiring the user to intake additional outside carbohydrate sources if their goal is inter-activity energy.

Also, such dissolvable tablets are often pre-dosed, which can limit the ability to adjust the amount of nutrients based on individual needs. This can be a disadvantage for endurance athletes who require precise nutrition amounts over long durations of activity. For tablets that do have some amount of carbohydrate included, the ratio of carbohydrates to electrolytes resulting from their ingestion is inappropriate for the tablet to be used as a source of carbohydrates, as they would ingest far more electrolytes than is appropriate. In a few cases, athletes may not prefer the tablet dosage form as it is mostly associated with medication and may not be as palatable as other forms of nutrition during endurance activities.

Therefore, there is a need for a simple yet effective careful formulation and packaging design to ensure that the product meets the needs of athletes while minimizing negative impacts. The proposed product should deliver appropriate ratios of carbohydrates and electrolytes while delivering both in volumes that are reasonable to meet the needs of endurance athletes participating in endurance activities.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The present invention, in one exemplary embodiment, is an effervescent elongated solid nutritional composition comprising a carbohydrate source; and an effervescing agent. The effervescent elongated solid nutritional composition is free from added sodium and provides energy in the form of carbohydrates to a user during sports, cycling, running, gymming, exercise, triathlon, and similar vigorous workouts.

In a preferred embodiment, the effervescent elongated solid nutritional composition is elongated rod-shaped with marked indent break points to facilitate breaking evenly. The marked indent breakpoints are formed over the rod by pressure molding. The carbohydrate source is selected from the group consisting of glucose, fructose, dextrose, sucrose, maltose, lactose, maltodextrin, and a mixture thereof. The effervescing agent is a mixture of sodium bicarbonate and citric acid, or similar.

In another embodiment, the effervescent elongated solid nutritional composition comprises a coloring agent and caffeine. The molded shape of the rod is functional for storage, transport, easy measurement/dosage in situ, and insertion into bottles. The molded breakpoints help athletes adjust dose accurately on the go. The coloring agent is used to delineate caffeine content or other variations, giving the user insight into their selection during the activity.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an effervescent elongated solid nutritional composition of the present invention, in accordance with an exemplary embodiment of the present invention.

FIG. 2 illustrates a top planar view of the effervescent elongated solid nutritional composition of FIG. 1.

### DETAILED DESCRIPTION

The innovation is now described with reference to the embodiments and drawings. In the following description, for purposes of explanation, numerous specific details are set forth in order to provide a thorough understanding thereof. It may be evident, however, that innovation can be practiced without these specific details. In other instances, well-known product shapes are shown in diagram form in order to facilitate a description thereof.

As noted above, there is a need for a simple and effective careful formulation and packaging design to ensure that the product meets the needs of athletes while minimizing negative impacts. The present invention, in one preferred embodiment, is an effervescent elongated solid nutritional composition comprising a carbohydrate source and an effervescing agent. The effervescent elongated solid nutritional composition is free from added sodium and provides energy to a user during sports, cycling, running, gymming, exercise, triathlon, and similar vigorous workouts.

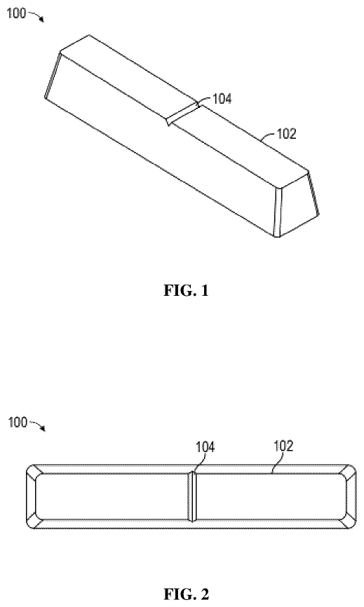

Referring initially to the drawings, FIG. 1 illustrates a perspective view of an effervescent elongated solid nutritional composition of the present invention, in accordance with the disclosed embodiment. More specifically, the present invention, in one exemplary embodiment, is an effervescent elongated solid nutritional composition 100 comprised of an elongated solid body 102 (rod-shaped) of a certain length or a predetermined length with or without one or more breaking points 104 to provide ease of breaking the effervescent elongated solid nutritional composition 100. In an embodiment, the elongated solid body 102 of the effervescent elongated solid nutritional composition 100 may be formed in specific doses (sizes) without any breakpoints. In another embodiment, the elongated solid body 102 of the effervescent elongated solid nutritional composition 100 may have at least one breakpoint configured over the body 102 to allow the user to break or divide the elongated rod-shaped solid composition 100 into multiple pieces with equal or unequal dose sizes so that the use can break the rod 100 into pieces to adjust the doses as they need to mix up with into their water bottle. The effervescent elongated solid nutritional composition 100 in the form of rods may be packaged in a bottle or a jar.

Similarly, FIG. 2 illustrates a top planar view of an effervescent elongated solid nutritional composition 100 of the present invention, in accordance with the disclosed embodiment.

In a preferred embodiment, the effervescent elongated solid nutritional composition 100 is a combination of carbohydrates in the form of sugar and maltodextrin, combined with an effervescing agent consisting of sodium bicarbonate and citric acid. No binding agents and added sodium are required for this composition. To shape it, water is added within a range of 0.1% to 3% by mass, and pressure molding is employed. The carbohydrates can be obtained in various forms, including glucose, fructose, dextrose, sucrose, maltose, maltodextrin, lactose, and others. The effervescent agent comprises an edible carbonic salt selected from sodium bicarbonate, sodium carbonate, potassium carbonate, calcium carbonateo, or a mixture thereof. Further, the effervescent agent comprises an edible acid selected from citric acid, malic acid, fumaric acid, ascorbic acid, tartaric acid, or a mixture thereof.

In a preferred embodiment, the effervescent elongated solid nutritional composition 100 of the present invention, when mixed with water, generates a carbohydrate solution with a concentration that varies/ranges from a minimum of 20 mmol/L to a maximum of 270 mmol/L. The proportion of glucose to fructose is generally 1:0.8, but it can range from 1:0.25 to 1:2. The effervescent agent, which includes sodium bicarbonate and citric acid, is present in an amount ranging from 3% to 15% of the dry weight of the carbohydrate mixture. In various embodiments, the composition when dissolved with water creates either a hypotonic solution, an isotonic, or a hypertonic solution with a carbohydrate concentration that is at least 20 mmol/liter. In an embodiment, the composition when dissolved with water, creates either a hypotonic solution, an isotonic, or a hypertonic solution resulting in a sodium concentration of at least 4 mmol/liter.

In a most preferred embodiment, the shape of the effervescent elongated solid nutritional composition 100 of the present invention, is intentionally molded as rods to fit into bottles, and it can be broken to adjust the dosage easily. The rods have indented marks that indicate ¼, ½, and ¾ lengths, which make dosage adjustment more convenient. Each rod has a finished dry mass ranging from 10 to 50 grams.

The key function of the carbohydrates in the effervescent elongated solid nutritional composition 100 of the present invention is to supply athletes with the required nutrition and energy during endurance activities. Sodium bicarbonate and citric acid act as dissolving agents, also supplying electrolytes as required by the body during high-intensity workouts. Caffeine is added optionally to improve endurance performance and mental alertness. To differentiate between caffeinated and non-caffeinated composition variants, a coloring agent is included.

The overall function of the invention is supported by the combination of the molded shape of the rods and the ingredients used. This provides athletes with a convenient and adaptable source of energy and nutrition during endurance activities.

The constituent parts of the product are all necessary for meeting user expectations. The carbohydrate source plays a vital role in providing energy and nutrition and thus cannot be omitted from the formulation. The rods 102 would not provide any nutritional energy without it. The effervescent agent is essential for satisfying customer demands. While the product would eventually dissolve without it, the duration would be longer than what users are willing to accept. Without the effervescence, the rods would require significant agitation and take 10-15 minutes to dissolve, leaving particulate in the solution. However, with the effervescence, the rods self-dissolve quickly and leave little to no particulate in the solution.

Although the dosing lines are not critical to the product's functionality, they do improve the user experience. While removing them would not ruin the product, they give users specific insight into their dosing adjustments.

As described throughout this application the terms “effervescent elongated solid nutritional composition”, “elongated rod”, and “rod”, have a similar meaning throughout the invention. The effervescent elongated solid nutritional composition of the present invention can be also referred to as a dosage form or a product. Finally, the effervescent elongated solid nutritional composition of the present invention is relatively more efficient, inexpensive, safe, and easy to use.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive like the term “comprising” as “comprising” is interpreted when employed as a transitional word in a claim.

What is claimed is:

1. An effervescent elongated solid nutritional composition, comprising:
(a) a carbohydrate source;
(b) an effervescing agent;
wherein the effervescent elongated solid nutritional composition is free from added sodium; and
wherein, the effervescent elongated solid nutritional composition provides energy to a user during sports, cycling, running, gymming, exercise, triathlon, and similar vigorous workouts.

2. The effervescent elongated solid nutritional composition of claim 1, wherein the carbohydrate source is selected from glucose, fructose, dextrose, sucrose, maltose, lactose, maltodextrin, and a mixture thereof.

3. The effervescent elongated solid nutritional composition of claim 1, wherein the effervescent agent comprises an edible carbonic salt selected from sodium bicarbonate, sodium carbonate, potassium carbonate, calcium carbonate, and a mixture thereof.

4. The effervescent elongated solid nutritional composition of claim 1, wherein the effervescent agent comprises an edible acid selected from citric acid, malic acid, fumaric acid, ascorbic acid, tartaric acid, and a mixture thereof.

5. The effervescent elongated solid nutritional composition of claim 1, wherein the effervescent elongated solid nutritional composition is produced by combining carbohydrates in the form of sugar and maltodextrin combined with the effervescing agent consisting of sodium bicarbonate and citric acid in the presence of water which is added within a range of 0.1% to 3% by mass.

6. The effervescent elongated solid nutritional composition of claim 1, wherein the effervescent elongated solid nutritional composition is formed by pressure molding.

7. The effervescent elongated solid nutritional composition of claim 1, wherein the effervescent elongated solid nutritional composition when dissolved with water creates either a hypotonic solution, an isotonic, or a hypertonic solution with a carbohydrate concentration that ranges from a minimum of 20 mmol/L to a maximum of 270 mmol/L.

8. The effervescent elongated solid nutritional composition of claim 1, wherein the carbohydrate source is a combination of sugar sources resulting in a final composition in a ratio of glucose and fructose of 1:0.25-2.

9. The effervescent elongated solid nutritional composition of claim 1, wherein the concentration of effervescent agent is between 3 and 15% of the dry mass of the carbohydrate source.

10. The effervescent elongated solid nutritional composition of claim 1, wherein the effervescent elongated solid nutritional composition when dissolved with water, creates either a hypotonic solution, an isotonic, or a hypertonic solution resulting in a sodium concentration of at least 4 mmol/liter.

11. The effervescent elongated solid nutritional composition of claim 1, wherein the effervescent elongated solid nutritional composition is rod-shaped.

12. The effervescent elongated solid nutritional composition of claim 1, wherein the effervescent elongated solid nutritional composition is breakable for adjusting the dosage at breakpoints.

13. The effervescent elongated solid nutritional composition of claim 1, wherein the effervescent elongated solid nutritional composition further comprises a coloring agent.

14. The effervescent elongated solid nutritional composition of claim 1, wherein the effervescent elongated solid nutritional composition further comprises caffeine.

15. An effervescent nutritional composition configured in the form of a solid elongated rod with at least one breakpoint located at a predetermined distance on the rod's body, the nutritional composition comprising:
(a) a carbohydrate source comprising: at least one glucose, fructose, dextrose, sucrose, maltose, lactose, maltodextrin, and a mixture thereof;
(b) an effervescing agent comprising: at least one
an edible carbonic salt selected from sodium bicarbonate, sodium carbonate, potassium carbonate, calcium carbonate, and a mixture thereof; or
an edible acid selected from citric acid, malic acid, fumaric acid, ascorbic acid, tartaric acid, and a mixture thereof;
(c) water added within a range of 0.1% to 3% by mass; and
wherein, the solid elongated rod is selectively breakable along the at least one breakpoint to adjust the dosage.

16. The effervescent nutritional composition of claim 15, wherein the effervescent nutritional composition when dissolved with water creates either a hypotonic solution, an isotonic, or a hypertonic solution with a carbohydrate concentration that ranges from a minimum of 20 mmol/L to a maximum of 270 mmol/L.

17. The effervescent nutritional composition of claim 15, wherein the carbohydrate source is a combination of sugar sources resulting in a final composition in a ratio of glucose and fructose of 1:0.25-2.

18. The effervescent nutritional composition of claim 15, wherein the concentration of effervescent agent is between 3 and 15% of the dry mass of the carbohydrate source.

19. The effervescent nutritional composition of claim 15, wherein the effervescent nutritional composition when dissolved with water, creates either a hypotonic solution, an isotonic, or a hypertonic solution resulting in a sodium concentration of at least 4 mmol/liter.

20. The effervescent nutritional composition of claim 15, wherein the effervescent nutritional composition further comprises a coloring agent.

21. The effervescent nutritional composition of claim 15, wherein the effervescent nutritional composition further comprises caffeine.

22. A method of manufacturing an effervescent nutritional composition, the method comprising steps of
(a) combining a carbohydrate source comprising: at least one glucose, fructose, dextrose, sucrose, maltose, lactose, maltodextrin, and a mixture thereof; and an effervescing agent comprising: at least one edible carbonic salt or edible acid to produce a mixture;
(b) adding water within a range of 0.1% to 3% by mass to the mixture; and
(c) applying pressure molding on the mixture to form an effervescent elongated solid nutritional composition, wherein the effervescent elongated solid nutritional composition is selectively breakable to adjust the dosage.

23. The method of claim 22, wherein the edible carbonic salt is selected from sodium bicarbonate, sodium carbonate, potassium carbonate, calcium carbonate, and a mixture thereof.

24. The method of claim 22, wherein the edible acid is selected from citric acid, malic acid, fumaric acid, ascorbic acid, tartaric acid, and a mixture thereof.

25. The method of claim 22, wherein the concentration of effervescent agent is between 3 and 15% of the dry mass of the carbohydrate source.

26. The method of claim 22 further comprising the steps of
adding a coloring agent to the mixture; and
adding caffeine to the mixture.

27. The method of claim 22, wherein the effervescent nutritional composition when dissolved with water creates either a hypotonic solution, an isotonic, or a hypertonic solution with a carbohydrate concentration that ranges from a minimum of 20 mmol/L to a maximum of 270 mmol/L.

28. The method of claim 22, wherein the carbohydrate source is a combination of sugar sources resulting in a final composition in a ratio of glucose and fructose of 1:0.25-2.

29. The method of claim 22, wherein the effervescent elongated solid nutritional composition is configured in the form of an elongated rod with at least one breakpoint along the length.
